(19) United States
(12) Patent Application Publication
(10) Pub. No.: US 2026/0289905 A1
(43) Pub. Date: Sep. 24, 2026

(54) METHOD FOR RETRIEVING 3D CONTENT USING MULTI-EMBEDDING AND APPARATUS USING THE SAME

(71) Applicant: Electronics and Telecommunications Research Institute, Daejeon (KR)

(72) Inventors: Su-Woong LEE, Sejong-si (KR); Seung-Jae LEE, Daejeon (KR); Ju-Won LEE, Daejeon (KR); Jong-Gook KO, Daejeon (KR); Yong-Sik LEE, Busan (KR); Da-Un JUNG, Daejeon (KR)

(21) Appl. No.: 19/245,098

(22) Filed: Jun. 20, 2025

(30) Foreign Application Priority Data
Mar. 21, 2025 (KR) 10-2025-0036640

(51) Int. Cl. G06T 17/00; G06F 16/483

(52) U.S. Cl. CPC G06T 17/00; G06F 16/483

(57) ABSTRACT

Disclosed herein are a method for retrieving 3D content based on multi-embedding and an apparatus for the same. The method, performed by the apparatus, includes segmenting a 3D object input by a user into major parts, generating a composite query set in which multiple queries are combined based on multi-embedding acquired by individually embedding the 3D object and the major parts, retrieving multiple candidate 3D objects from a database based on similarity to the composite query set, and providing a single 3D object selected by the user, among the multiple candidate 3D objects, as a final retrieval result depending on whether retrieval is completed through user interaction.

### CROSS REFERENCE TO RELATED APPLICATION

This application claims priority under 35 U.S.C § 119 to Korean Patent Application No. 10-2025-0036640 filed in the Korean Intellectual Property Office on Mar. 21, 2025, which is hereby incorporated by reference in its entirety into this application.

### BACKGROUND OF THE INVENTION

### 1. Technical Field

The present disclosure relates generally to technology for retrieving 3D content based on multi-embedding, and more particularly to technology for retrieving 3D content using similarity of 3D content and user interaction.

### 2. Description of the Related Art

Since the recent publication of CLIP, which is a large-scale text-image model, various follow-up studies using the representation power of CLIP are underway. For example, ULIP is the study to add 3D model recognition capabilities to the text-image recognition capabilities of CLIP and is regarded as the first study to generate a co-embedding of text, image, and 3D shape.

Since then, OpenShape trained on the large-scale Objaverse dataset in order to achieve open-world understanding, which led to improvement in both model size and performance. Uni3D also adopts a contrastive learning framework from ULIP and OpenShape and provides various baselines applicable to various datasets and tasks based on a transformer. Compared to ULIP, ULIP-2 improves alignment between text, image, and 3D shape by employing more sophisticated training techniques and a larger dataset and provides good performance particularly in the field of 3D-to-3D retrieval.

Meta has developed technology related to interaction between a user and a 3D web in an artificial reality environment. This technology determines the form of content of a specific region of a website selected by a user and provides associated content, such as 3D content, panoramic content, etc., thereby enabling a natural user experience.

Google has developed technology related to embeddings for media content search and indexing and privacy controls for sharing the embeddings. This technology proposes a method for indexing media content by collecting facial images of users and applying machine-learning models. This technology also enables secure control of access to the indexed information through a digital key shared between a first user and a second user.

Snap has developed technology related to a user-friendly support interface. This technology has proposed an interactive interface system that receives a message request from a client device, converts a natural language request into a query term, and retrieves and displays associated media content based on the query term.

Image caption technology, which automatically generates text for describing an input image using a foundation model, is also being actively researched, and BLIP is a representative example thereof.

Also, technology for performing segmentation of a 3D model has recently been researched, and Point-SAM is a representative example thereof.

As described above, the existing 3D object retrieval studies successfully aligned 3D shape together with text and image in a CLIP embedding space, but they derive only a single embedding for the 3D shape of the entire object, so it is difficult to precisely retrieve a 3D model desired by a user. Also, existing technologies related to user interaction recognize content in a specific region of a website, users, or user queries and provide user-friendly user experience associated therewith, but they do not present a sophisticated retrieval method that iteratively retrieve associated content from a 3D shape retrieval result.

### DOCUMENTS OF RELATED ART

(Patent Document 1) U.S. Patent Application Publication US2024/0202796, published on Jun. 20, 2024 and titled “Search with machine-learned model-generated queries”.

### SUMMARY OF THE INVENTION

An object of the present disclosure is to provide a user-friendly interaction interface capable of more accurately retrieving a 3D shape desired by a user.

Another object of the present disclosure is to provide a method for retrieving a 3D object using the feature of each part of the object by segmenting the object into major parts and acquiring multiple embeddings for the features of the respective parts.

A further object of the present disclosure is to provide a method for retrieving a 3D object while continuously performing interaction with a user.

In order to accomplish the above objects, a method for retrieving 3D content based on multi-embedding, performed by a 3D content retrieval apparatus, according to the present disclosure includes segmenting a 3D object input by a user into major parts, generating a composite query set in which multiple queries are combined based on multi-embedding acquired by individually embedding the 3D object and the major parts, retrieving multiple candidate 3D objects from a database based on similarity to the composite query set, and providing a single 3D object selected by the user, among the multiple candidate 3D objects, as a final retrieval result depending on whether retrieval is completed through user interaction.

Here, the method may further include constructing, by the 3D content retrieval apparatus, the database, and constructing the database may include extracting a major part set from an entire 3D object set stored in the database and embedding the same, extracting an object subset based on prior knowledge from the entire 3D object set and embedding the same, and extracting a multimodal feature encoder set from the entire 3D object set and embedding the same.

Here, extracting and embedding the multimodal feature encoder set may comprise embedding multimodal data for the entire 3D object set into a single space.

Here, the multimodal data may include text data, image data, and 3D data.

Here, the method may further include performing, by the 3D content retrieval apparatus, subsequent retrieval by inputting the single 3D object selected by the user as a reference 3D object when the retrieval is not completed according to the user interaction.

Here, generating the composite query set may include acquiring a user-specified part in consideration of whether the reference 3D object is input and updating the composite query set by adding a result of embedding the user-specified part to the composite query set.

Here, acquiring the user-specified part may comprise, when the reference 3D object is input, segmenting the reference 3D object into major parts with reference to the database and acquiring a major part selected by the user, among the major parts of the reference 3D object, as the user-specified part.

Here, acquiring the user-specified part may comprise, when the reference 3D object is not input, acquiring a major part, the feature of which is input after being selected by the user from the major part set, as the user-specified part.

Here, generating the composite query set may further include assigning a weight to each query parts constituting the composite query set.

Here, retrieving the multiple candidate 3D objects may include acquiring a retrieval target object set from the entire 3D object set, measuring similarity between the composite query set and all elements of the retrieval target object set, sorting 3D objects retrieved based on the similarity in descending order of similarity, and setting top N 3D objects, among the sorted 3D objects, as the multiple candidate 3D objects.

Also, an apparatus for retrieving 3D content according to an embodiment of the present disclosure includes a database for embedding and storing a 3D object and a processor for segmenting a 3D object input by a user into major parts, generating a composite query set in which multiple queries are combined based on multi-embedding acquired by individually embedding the 3D object and the major parts, retrieving multiple candidate 3D objects from the database based on similarity to the composite query set, and providing a single 3D object selected by the user, among the multiple candidate 3D objects, as a final retrieval result depending on whether retrieval is completed through user interaction.

Here, the processor may construct the database, extract a major part set from an entire 3D object set stored in the database and embed the same, extract an object subset based on prior knowledge from the entire 3D object set and embed the same, and extract a multimodal feature encoder set from the entire 3D object set and embed the same.

Here, the processor may embed multimodal data for the entire 3D object set into a single space.

Here, the multimodal data may include text data, image data, and 3D data.

Here, when the retrieval is not completed according to the user interaction, the processor may perform subsequent retrieval by inputting the single 3D object selected by the user as a reference 3D object.

Here, the processor may acquire a user-specified part in consideration of whether the reference 3D object is input and may update the composite query set by adding a result of embedding the user-specified part to the composite query set.

Here, when the reference 3D object is input, the processor may segment the reference 3D object into major parts with reference to the database and acquire a major part selected by the user, among the major parts of the reference 3D object, as the user-specified part.

Here, when the reference 3D object is not input, the processor may acquire a major part, the feature of which is input after being selected by the user from the major part set, as the user-specified part.

Here, the processor may assign a weight to each query parts constituting the composite query set.

Here, the processor may acquire a retrieval target object set from the entire 3D object set, measure similarity between the composite query set and all elements of the retrieval target object set, sort 3D objects retrieved based on the similarity in descending order of similarity, and set top N 3D objects, among the sorted 3D objects, as the multiple candidate 3D objects.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a flowchart illustrating a method for retrieving 3D content based on multi-embedding according to an embodiment of the present disclosure;

FIG. 2 is a flowchart illustrating in detail the process of constructing a database in a 3D content retrieval method according to the present disclosure;

FIG. 3 is a flowchart illustrating in detail the process of updating a composite query set in a 3D content retrieval method according to the present disclosure;

FIG. 4 is a flowchart illustrating in detail the process of selecting a final retrieval result through user interaction in a 3D content retrieval method according to the present disclosure;

FIG. 5 is a view illustrating an example of segmentation of a 3D object into major parts according to the present disclosure;

FIG. 6 is a view illustrating an example of a composite query set configured with the major parts illustrated in FIG. 5 and an example of candidate 3D objects derived through the composite query set;

FIG. 7 is a block diagram illustrating an apparatus for retrieving 3D content based on multi-embedding according to an embodiment of the present disclosure; and

FIG. 8 is a view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

Hereinafter, a preferred embodiment of the present disclosure will be described in detail with reference to the accompanying drawings.

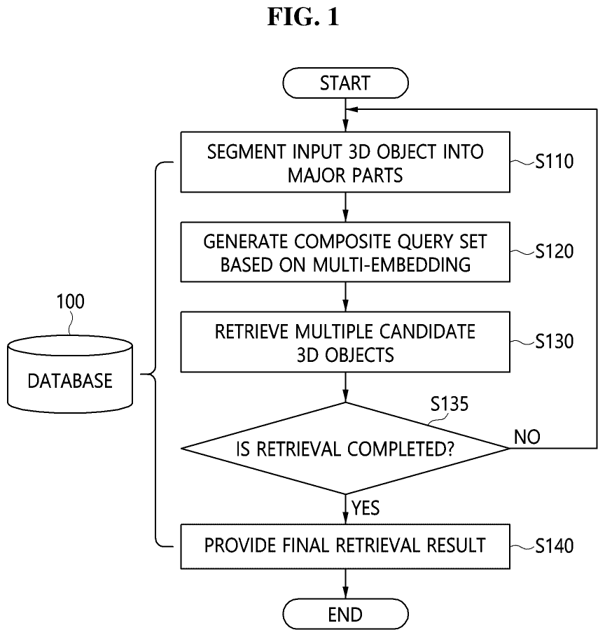

FIG. 1 is a flowchart illustrating a method for retrieving 3D content based on multi-embedding according to an embodiment of the present disclosure.

Referring to FIG. 1, in the method for retrieving 3D content based on multi-embedding according to an embodiment of the present disclosure, a 3D content retrieval apparatus segments a 3D object input by a user into major parts at step S110.

Here, an entire 3D object set O_{Ω}, a subset Oᵢ of O_{Ω}, which is selected by predefined criteria, and a feature encoder set F for embedding multimodal data, such as text, images, 3D data, etc., into a single space may be predefined in a database 100.

Here, the feature encoder set F may include Fₜₑₓₜ, F_{image}, and F_{3D} to transform the features of text, an image, and 3D data into an aligned embedding space.

Hereinafter, the process of constructing a database will be sequentially described.

Here, although not illustrated in FIG. 1, in the method for retrieving 3D content based on multi-embedding according to an embodiment of the present disclosure, the 3D content retrieval apparatus may construct a database.

Here, a major part set may be extracted from the entire 3D object set stored in the database and then be embedded.

Here, an object subset based on prior knowledge may be extracted from the entire 3D object set and then be embedded.

Here, a multimodal feature encoder set may be extracted from the entire 3D object set and then be embedded.

Here, multimodal data for the entire 3D object set may be embedded into a single space.

Here, the multimodal data may include text data, image data, and 3D data.

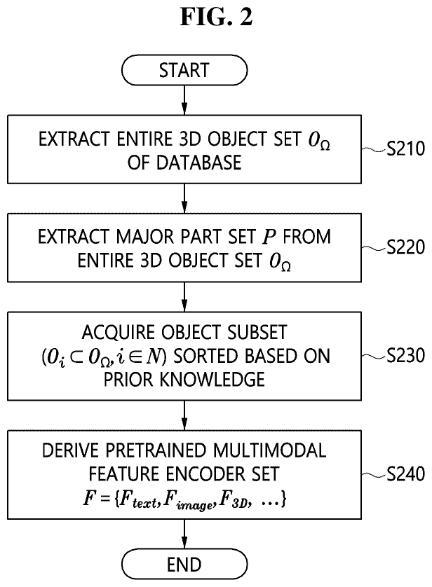

For example, referring to FIG. 2, first, O_{Ω} that is the set of all 3D objects stored in the database may be loaded at step S210.

Here, the entire 3D object set O_{Ω} may be the target to be searched.

Subsequently, a major part set P may be extracted from the entire 3D object set O_{Ω} at step S220.

For example, major parts of a 3D object may be extracted using image captioning technology such as BLIP.

Here, the process of extracting the major part set is a preparation process for performing retrieval and analysis based on specific parts or features of a 3D object, which may assist a retrieval system in handling more sophisticated queries. Also, because the major part set P includes a whole object, which is the entirety of the 3D object, by default, the features of the entire object may be used for retrieval.

Subsequently, an object subset Oᵢ (Oᵢ c O_{Ω}, i∈N) that is sorted using prior knowledge may be extracted at step S230.

For example, the object subset Oᵢ may be dogs, animals, household items, and the like.

Here, the object subset Oᵢ may be useful to narrow the retrieval range when the entire 3D object set O_{Ω} is large.

Subsequently, the pretrained multimodal feature encoder set F may be derived at step S240.

Here, the multimodal feature encoder set F serves to map the multimodal input into a unified embedding space and may be defined differently for each type of multimodal data (text, images, 3D data, etc.). For example, encoders proposed by ULIP, OpenShape, and Uni3D may be used as a multimodal encoder.

Also, in the method for retrieving 3D content based on multi-embedding according to an embodiment of the present disclosure, the 3D content retrieval apparatus generates a composite query set in which multiple queries are combined based on multi-embedding acquired by individually embedding the 3D object and the major parts at step S120.

That is, at step S120, a composite query set Q may be generated using multi-embedding of the entire object or a part based on the input data of a user. The composite query set Q generated in this way may be transformed into vectors that can be used for retrieval by embedding various formats of input data, such as text, images, 3D objects, and the like.

Here, in consideration of whether a reference 3D object is input, a user-specified part is derived, and a result of embedding the user-specified part is added to the composite query set, whereby the composite query set may be updated.

Here, when a reference 3D object is input, the reference 3D object is segmented into major parts with reference to the database, and a major part selected by the user from among the major parts of the 3D object may be acquired as the user-specified part.

Here, when no reference 3D object is input, the major part, the feature of which is input after being selected by the user from the major part set, may be acquired as the user-specified part.

Here, a weight may be assigned to each query parts constituting the composite query set.

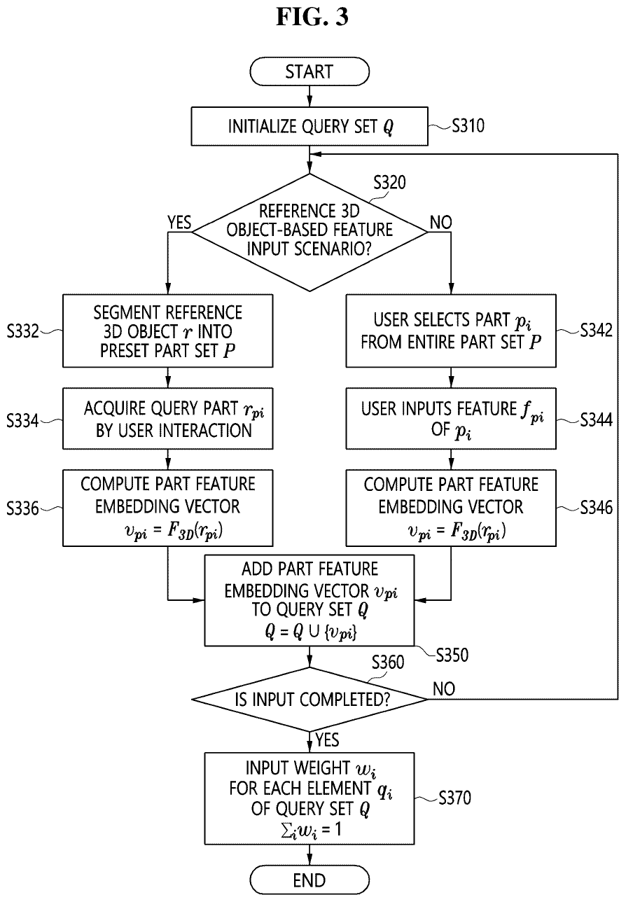

Hereinafter, the process of generating a composite query set will be described in more detail with reference to FIG. 3.

Referring to FIG. 3, first, a query set Q is initialized at step S310, and whether the process proceeds according to a scenario based on a reference 3D object may be checked at step S320.

Here, the query set Q may be initialized to an empty set.

Here, the branching process according to step S320 may be performed by asking a user whether or not to start the input based on the reference 3D object.

When the user selects YES at step S320, the selected reference 3D object r may be segmented into preset parts that constitute a part set P at step S332.

Here, technology such as point-SAM or the like may be used.

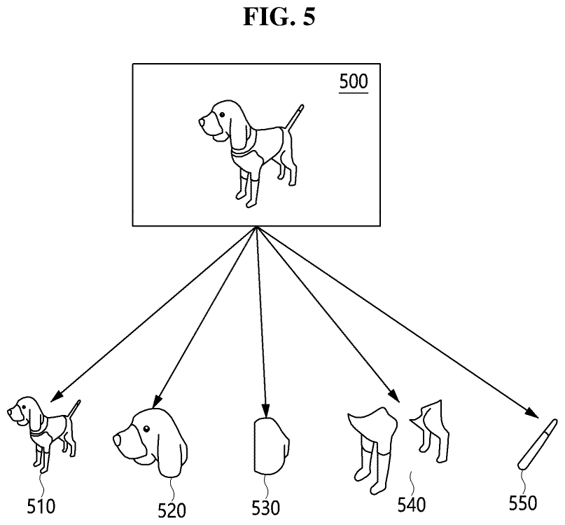

For example, referring to FIG. 5, the reference 3D object 500 in the shape of a dog may be segmented into several major parts 510 to 550. Here, the respective major parts may be generated as objects.

Subsequently, a specific part rₚᵢ to be queried may be acquired through user interaction at step S334.

Here, the user may select the desired part from among the multiple parts acquired by segmenting the provided reference 3D object.

Subsequently, an embedding vector vₚᵢ=F_{3D}(rₚᵢ) of the part selected by the user is computed, whereby the part may be represented numerically at step S336.

Here, the computed embedding vector may be used later to compute similarity.

Also, when the user selects NO at step S320, the query part pi to be retrieved is selected by the user from the entire part set P, without using a reference 3D object, at step S342.

Subsequently, when the user enters a feature for the selected part pi at step S344, an embedding vector vₚᵢ=Fₚᵢ (fₚᵢ) for the feature of the part may be computed at step S346.

For example, when the user enters “spotted body”, which corresponds to text data, as the feature of the part, the embedding vector for “spotted body” may be computed.

The embedding vector computed in this way may also be used later to compute similarity.

Here, Fₚᵢ is one element of F and may be determined by the type of fₚᵢ. That is, when fₚᵢ is text, Fₜₑₓₜ may be used as Fₚᵢ.

Subsequently, when step S336 or step S346 ends, the embedded part vector vₚᵢ is added to the query set Q to extend the information required for retrieval at step S350.

Here, the process at step S350 may be represented as shown in Equation (1):

$$Q = Q ⋃ \{ {v}_{pi} \} \qquad ( 1 )$$

When the query set Q is updated at step S350, whether the input is completed may be checked at step S360.

Here, the user may check whether additional input is required, and when it is determined at step S360 that the input is not completed, the user may input additional information by returning to step S320 and repeat the subsequent processes.

Also, when it is determined at step S360 that the input is completed, a weight wᵢ for each of the elements of the composite query set Q is input, whereby the importance of each query part may be set at step S370.

Here, the weights may be adjusted such that the total thereof is 1.

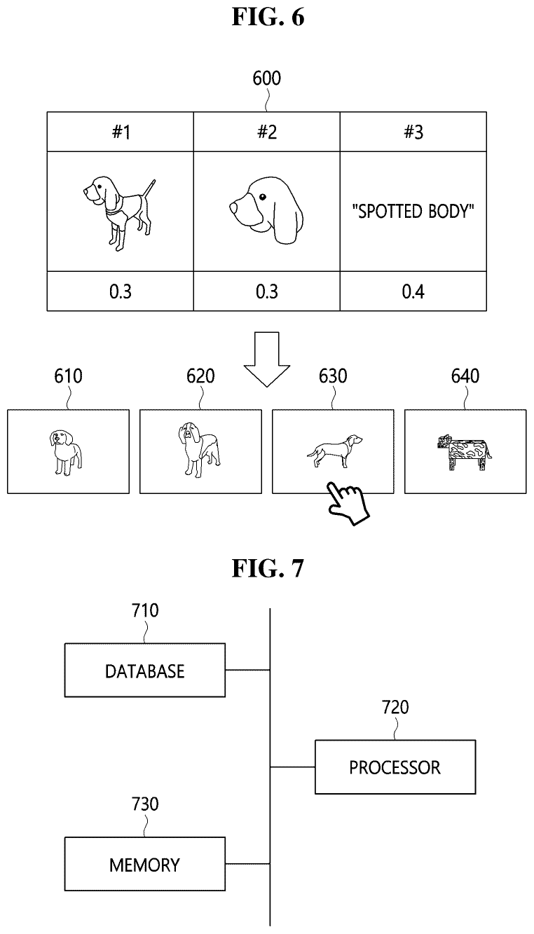

For example, a composite query set Q such as that (600) illustrated in FIG. 6 may be generated based on the major parts illustrated in FIG. 5. The composite query set Q illustrated in FIG. 6 includes three embeddings, and the entire object, the head, and the text (“spotted body”) to which weights of 0.3, 0.3, and 0.4 are applied are combined in the composite query set.

Also, in the method for retrieving 3D content based on multi-embedding according to an embodiment of the present disclosure, the 3D content retrieval apparatus retrieves multiple candidate 3D objects from the database based on the similarity to the composite query set at step S130.

That is, the similarity is computed by comparing the composite query set Q to which the weights are applied with embeddings stored in the database, and results most suitable for the user, among the results retrieved based on the computed similarity, may be displayed as the multiple candidate 3D objects.

Here, a retrieval target object set may be acquired from the entire 3D object set.

Here, the similarity between the composite query set and all elements of the retrieval target object set may be measured.

Here, the 3D objects retrieved based on the similarity may be sorted in descending order of similarity.

Here, the top N 3D objects, among the sorted 3D objects, may be set as the multiple candidate 3D objects.

Also, in the method for retrieving 3D content based on multi-embedding according to an embodiment of the present disclosure, the 3D content retrieval apparatus checks whether the retrieval of the 3D object is completed through user interaction at step S135, and when the retrieval is not completed according to the user interaction, subsequent retrieval may be performed by inputting a single 3D object selected by the user as a reference 3D object.

Also, in the method for retrieving 3D content based on multi-embedding according to an embodiment of the present disclosure, when it is determined at step S315 that retrieval is completed through user interaction, the 3D content retrieval apparatus provides a single 3D object selected by the user from among the multiple candidate 3D objects as the final retrieval result at step S140.

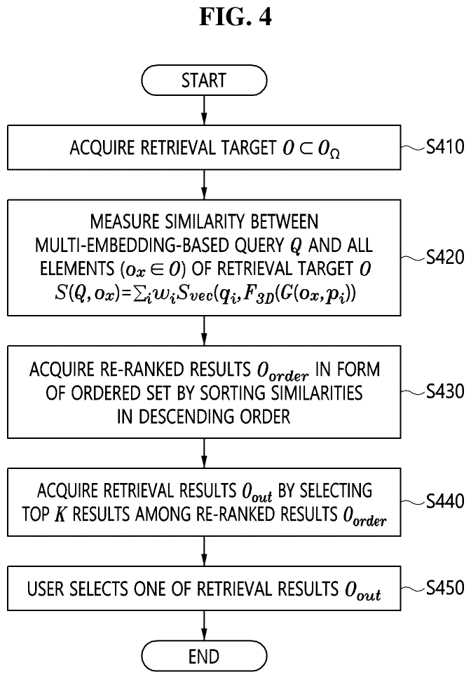

Hereinafter, the process from step S130 to step S140 will be described in detail with reference to FIG. 4.

Referring to FIG. 4, first, a retrieval target object set O⊂O_{Ω} may be acquired from a database at step S410.

Here, the retrieval target object set O is a set of target objects that can be retrieved, and it may correspond to objects whose similarity to the composite query set are to be measured in the subsequent process.

For example, the retrieval target object set O may be selected in various manners according to the scenario, and the entire 3D object set O_{Ω} in the database or a predefined subset, Oᵢ in FIG. 2, may be used as the retrieval target object set O. Alternatively, a subset of O_{Ω} retrieved based on another algorithm may be selected and used as the retrieval target object set.

Subsequently, the similarity between the composite query set Q based on multi-embedding and the retrieval target object set O may be measured at step S420.

Here, the similarity between the composite query set Q based on multi-embedding and all elements (oₓ∈O) of the retrieval target object set O may be measured.

Here, a similarity measurement function may be defined as shown in Equation (2):

$$S ( Q , {o}_{x} ) = {\sum }_{i} {w}_{i} {S}_{vec} ( {q}_{i} , {F}_{3 D} ( G ( {o}_{x} , {p}_{i} ) ) ) \qquad ( 2 )$$

Here, wᵢ may denote the weight assigned to each query vector, S_{vec} may denote the function for computing the similarity between vectors, F_{3D} may denote the 3D object embedding function, and G(oₓ,pᵢ) may denote the function for separating the area corresponding to the query part pᵢ from the object oₓ.

Subsequently, the retrieved objects based on the similarity may be sorted in descending order, and the sorted results may be derived as O_{order} in the form of a re-ranked ordered set at step S430.

Subsequently, the top K objects of the reranked ordered set O_{order} are selected, whereby the candidate retrieval results, Oₒᵤₜ, may be acquired at step S440.

That is, the multiple candidate retrieval results, Oₒᵤₜ, may correspond to objects selected as the objects that are most similar to the 3D object input by the user.

For example, referring to FIG. 6, the similarity to the composite query set 600 is computed, and the most similar top K candidate 3D objects 610 to 640 may be displayed.

Subsequently, the user may select one of the sorted candidate retrieval results Oₒᵤₜ as the final retrieval result or may use the selected one as a reference object when it is determined that the desired result is not yet retrieved at step S450.

Here, Oₒᵤₜ may also be used as an object subset for step S410.

For example, referring to FIG. 6, the user may select one of the displayed candidate 3D objects 610 to 640 and use the same as the final retrieval result or as a reference object at the subsequent step.

Through the above-described method for retrieving 3D content based on multi-embedding, a user-friendly interaction interface through which a 3D shape desired by a user can be more accurately retrieved may be provided.

Also, an object is segmented into major parts, and multiple embeddings for the features of the respective parts are acquired, whereby a method for retrieving a 3D object using the feature of each part of the object may be provided.

Also, a method for retrieving a 3D object while continuously performing interaction with a user may be provided.

FIG. 7 is a block diagram illustrating an apparatus for retrieving 3D content based on multi-embedding according to an embodiment of the present disclosure.

Referring to FIG. 7, the apparatus for retrieving 3D content based on multi-embedding according to an embodiment of the present disclosure includes a database 710, a processor 720, and memory 730.

The database 710 embeds and stores a 3D object.

The processor 720 may construct the database 710, extract a major part set from an entire 3D object set stored in the database 710 and embed the same, extract an object subset based on prior knowledge from the entire 3D object set and embed the same, and extract a multimodal feature encoder set from the entire 3D object set and embed the same.

Here, multimodal data for the entire 3D object set may be embedded into a single space.

Here, the multimodal data may include text data, image data, and 3D data.

Also, the processor 720 segments a 3D object input by a user into major parts.

Also, the processor 720 generates a composite query set in which multiple queries are combined based on multi-embedding acquired by individually embedding the 3D object and the major parts.

Also, the processor 720 may acquire a user-specified part in consideration of whether a reference 3D object is input and may update the composite query set by adding a result of embedding the user-specified part to the composite query set.

Here, when a reference 3D object is input, the reference 3D object may be segmented into major parts with reference to the database, and a part selected by the user from among the major parts of the reference 3D object may be acquired as the user-specified part.

Here, when no reference 3D object is input, a major part, the feature of which is input after being selected by the user from the major part set, may be acquired as the user-specified part.

Also, the processor 720 may assign a weight to each query parts constituting the composite query set.

Also, the processor 720 retrieves multiple candidate 3D objects from the database based on similarity to the composite query set.

Also, the processor 720 provides a single 3D object selected by the user from among the multiple candidate 3D objects as a final retrieval result depending on whether retrieval is completed through user interaction.

Here, when retrieval is not completed according to the user interaction, subsequent retrieval may be performed by inputting the single 3D object selected by the user as the reference 3D object.

Here, a retrieval target object set is acquired from the entire 3D object set, the similarity between the composite query set and all elements of the retrieval target object set is measured, 3D objects retrieved based on the similarity are sorted in descending order of similarity, and the top N 3D objects, among the sorted 3D objects, may be set as the multiple candidate 3D objects.

Here, because a specific operation process performed through the processor 720 has been described in detail in the description of the 3D content retrieval method in FIG. 1, a description thereof will be omitted.

The memory 730 stores various kinds of information generated in the process of retrieving 3D content based on multi-embedding according to an embodiment of the present disclosure as described above.

An embodiment of the present disclosure may be implemented in a computer system including a computer-readable recording medium. Here, the computer system may include one or more processors, memory, a user input device, a user output device, and storage, which communicate with each other via a bus. Also, the computer system may further include a network interface connected to a network. The processor may be a central processing unit or a semiconductor device for executing processing instructions stored in the memory or the storage. The memory and the storage may be any of various types of volatile or nonvolatile storage media. For example, the memory may include ROM or RAM.

Accordingly, an embodiment of the present disclosure may be implemented as a non-transitory computer-readable medium in which methods implemented using a computer or instructions executable in a computer are recorded. When the computer-readable instructions are executed by a processor, the computer-readable instructions may perform a method according to at least one aspect of the present disclosure.

Using the above-described apparatus for retrieving 3D content based on multi-embedding, a user-friendly interaction interface through which a 3D shape desired by a user can be more accurately retrieved may be provided.

Also, an object is segmented into major parts, and multiple embeddings for features of the respective parts are acquired, whereby a method for retrieving a 3D object using the feature of each part of the object may be provided.

Also, a method for retrieving a 3D object while continuously performing interaction with a user may be provided.

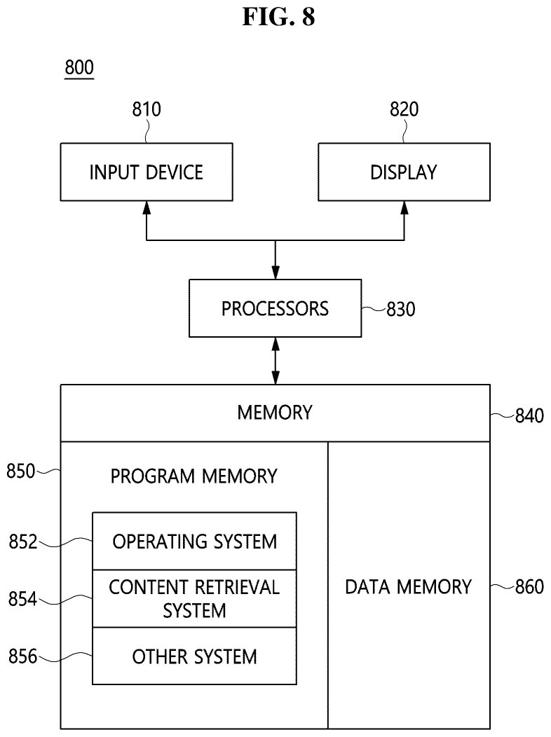

FIG. 8 is a view illustrating a computer system according to an embodiment of the present disclosure.

Referring to FIG. 8, 3D content retrieval proposed in the present disclosure may be performed in a hardware configuration similar to the system illustrated in FIG. 8.

Processors 830 may exchange information with an input device 810 for receiving input from a user and a display 820 for displaying the current state to the user and may exchange information about the current state of a program with memory 840.

Here, the memory 840 may be divided into program memory 850 for storing information about an operating system and applications and data memory 860 for storing user information and other data. The operating system 852 in the program memory 850 may perform interface between hardware and the applications, and a content retrieval system 854 running on the operating system may perform 3D retrieval. Also, in addition to the content retrieval system 854, the memory of other systems 856 may also be included in the program memory 850.

According to the present disclosure, a user-friendly interaction interface capable of more accurately retrieving a 3D shape desired by a user may be provided.

Also, the present disclosure may provide a method for retrieving a 3D object using the feature of each part of the object by segmenting the object into major parts and acquiring multiple embeddings for the features of the respective parts.

Also, the present disclosure may provide a method for retrieving a 3D object while continuously performing interaction with a user.

As described above, the method for retrieving 3D content based on multi-embedding and the apparatus for the same according to the present disclosure are not limitedly applied to the configurations and operations of the above-described embodiments, but all or some of the embodiments may be selectively combined and configured, so the embodiments may be modified in various ways.

What is claimed is:

1. A method for retrieving 3D content, performed by a 3D content retrieval apparatus, comprising:
segmenting a 3D object input by a user into major parts;
generating a composite query set in which multiple queries are combined based on multi-embedding obtained by individually embedding the 3D object and the major parts;
retrieving multiple candidate 3D objects from a database based on similarity to the composite query set; and
providing a single 3D object selected by the user, among the multiple candidate 3D objects, as a final retrieval result depending on whether retrieval is completed through user interaction.

2. The method of claim 1, further comprising:
constructing, by the 3D content retrieval apparatus, the database,
wherein constructing the database comprises
extracting a major part set from an entire 3D object set stored in the database and embedding the major part set;
extracting an object subset based on prior knowledge from the entire 3D object set and embedding the object subset; and
extracting a multimodal feature encoder set from the entire 3D object set and embedding the multimodal feature encoder set.

3. The method of claim 2, wherein extracting and embedding the multimodal feature encoder set comprises embedding multimodal data for the entire 3D object set into a single space.

4. The method of claim 3, wherein the multimodal data includes text data, image data, and 3D data.

5. The method of claim 2, further comprising:
when the retrieval is not completed according to the user interaction, performing, by the 3D content retrieval apparatus, subsequent retrieval by inputting the single 3D object selected by the user as a reference 3D object.

6. The method of claim 5, wherein generating the composite query set comprises
acquiring a user-specified part in consideration of whether the reference 3D object is input; and
adding a result of embedding the user-specified part to the composite query set, thereby updating the composite query set.

7. The method of claim 6, wherein acquiring the user-specified part comprises, when the reference 3D object is input, segmenting the reference 3D object into major parts with reference to the database and acquiring a major part selected by the user, among the major parts of the reference 3D object, as the user-specified part.

8. The method of claim 6, wherein acquiring the user-specified part comprises, when the reference 3D object is not input, acquiring a major part, a feature of which is input after being selected by the user from the major part set, as the user-specified part.

9. The method of claim 1, wherein generating the composite query set comprises assigning a weight to each query parts constituting the composite query set.

10. The method of claim 2, wherein retrieving the multiple candidate 3D objects comprises
acquiring a retrieval target object set from the entire 3D object set;
measuring similarity between the composite query set and all elements of the retrieval target object set;
sorting 3D objects retrieved based on the similarity in descending order of similarity; and
setting top N 3D objects, among the sorted 3D objects, as the multiple candidate 3D objects.

11. An apparatus for retrieving 3D content, comprising:
a database for embedding and storing a 3D object; and
a processor for segmenting a 3D object input by a user into major parts, generating a composite query set in which multiple queries are combined based on multi-embedding acquired by individually embedding the 3D object and the major parts, retrieving multiple candidate 3D objects from the database based on similarity to the composite query set, and providing a single 3D object selected by the user, among the multiple candidate 3D objects, as a final retrieval result depending on whether retrieval is completed through user interaction.

12. The apparatus of claim 11, wherein
the processor constructs the database; and
the processor extracts a major part set from an entire 3D object set stored in the database and embeds the major part set, extracts an object subset based on prior knowledge from the entire 3D object set and embeds the object subset, and extracts a multimodal feature encoder set from the entire 3D object set and embeds the multimodal feature encoder set.

13. The apparatus of claim 12, wherein the processor embeds multimodal data for the entire 3D object set into a single space.

14. The apparatus of claim 13, wherein the multimodal data includes text data, image data, and 3D data.

15. The apparatus of claim 12, wherein, when the retrieval is not completed according to the user interaction, the processor performs subsequent retrieval by inputting the single 3D object selected by the user as a reference 3D object.

16. The apparatus of claim 15, wherein the processor acquires a user-specified part in consideration of whether the reference 3D object is input and adds a result of embedding the user-specified part to the composite query set, thereby updating the composite query set.

17. The apparatus of claim 15, wherein, when the reference 3D object is input, the processor segments the reference 3D object into major parts with reference to the database and acquires a major part selected by the user, among the major parts of the reference 3D object, as a user-specified part.

18. The apparatus of claim 16, wherein, when the reference 3D object is not input, the processor acquires a major part, a feature of which is input after being selected by the user from the major part set, as the user-specified part.

19. The apparatus of claim 11, wherein the processor assigns a weight to each query parts constituting the composite query set.

20. The apparatus of claim 12, wherein the processor acquires a retrieval target object set from the entire 3D object set, measures similarity between the composite query set and all elements of the retrieval target object set, sorts 3D objects retrieved based on the similarity in descending order of similarity, and sets top N 3D objects, among the sorted 3D objects, as the multiple candidate 3D objects.
